(19) United States
(12) Patent Application Publication
(10) Pub. No.: US 2010/0275251 A1
(43) Pub. Date: Oct. 28, 2010

(54) TRANSFERRING CREDENTIAL INFORMATION

(76) Inventors: Curtis T. Gross, Rocklin, CA (US); James M. Feldman, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/431,169

(22) Filed: Apr. 28, 2009

(51) Int. Cl. H04L 9/32; G06F 21/00

(52) U.S. Cl. 726/6; 726/12; 709/217

(57) ABSTRACT

Credential information is received from a credential transfer server. The credential transfer server is identified by sending a credential transfer message to a network entity identified by a dynamic host configuration protocol server.

### BACKGROUND

In networked computing environments, when a new device is added to the network, the device must be configured. In early networked computing environments, much, if not all, configuration was done manually. For example, TCP/IP parameters, such as the IP address, gateway address, and DNS server addresses were all entered manually.

As the art of computing advanced, several protocols emerged to help automatic various configuration tasks. For example, the Dynamic Host Configuration Protocol (DHCP) allows a client to receive an IP address, a gateway address, and a DNS server addresses from a DHCP server. Similarly, the Preboot Execution Environment (PXE) uses several network protocols to facilitate a client computer booting from a network interface coupled via a network to a PXE server.

However, while there have been advances, introducing a new client computer into an existing network still often requires a certain amount of manual configuration. The manual configuration steps add cost and provide opportunities for misconfiguration due to user error.

### BRIEF DESCRIPTION OF THE DRAWINGS

The Figures depict embodiments, implementations, and configurations of the invention, and not the invention itself.

FIG. 1 illustrates a network environment in which embodiments of the present invention may be deployed.

FIG. 2 illustrates another network environment in which embodiments of the present invention may be deployed.

FIG. 3A illustrates a Dynamic Credential Transfer (DCT) server, in accordance with embodiments of the present invention.

FIG. 3B illustrates a DCT proxy, in accordance with embodiments of the present invention.

FIG. 4 illustrates a DCT client, in accordance with embodiments of the present invention.

FIG. 5 illustrates a flowchart that describes how a client computer or device seeking credential information obtains credential information from a DCT server, in accordance with embodiments of the present invention.

FIG. 6 illustrates a flowchart showing another method of finding a DCT server, in accordance with embodiments of the present invention.

FIG. 7 is a perspective view showing a server that will be configured with a hostname, username, and password, in accordance with embodiments of the present invention.

FIG. 8 is a block diagram showing a network environment in which the server of FIG. 7 will be deployed, in accordance with embodiments of the present invention.

### DETAILED DESCRIPTION

In accordance with embodiments of the present invention, credential information is transferred from a server to a client. Before discussing the embodiments in greater detail, first consider several network environments and situations that would benefit from embodiments of the present invention.

In large data centers, computer systems are often managed using out-of-band management, which is also known in the industry as lights-out management (LOM). Many servers provided by Hewlett-Packard Company use a variant of LOM called Integrated Lights-Out, or iLO.

Often server computers are deployed into an LOM environment with an operating system (OS) preinstalled at the factory. Usually a tag is attached to the server, with the tag having default settings for a hostname, username, password, and any other information needed to provide initial access to the server. This information is typically different for each computer. When the computer is installed, the installer notes the default settings. Typically the default settings will be changed after initial access to the computer. As can be seen from the above description, this process requires manual configuration by the installer, and there are opportunities for user error when the information is noted, when initial access is attempted, and when final settings are entered. A server computer configured in accordance with the present invention can automatically and dynamically be configured with the credential information that was entered manually with prior solutions.

Server computers can also be shipped from the factory without any OS installed. Such computers are typically configured to perform an initial boot from the network using a method such as a Preboot Execution Environment (PXE) boot, which provides boot routines from a PXE server. While this is an improvement over the manual configuration method described above, at some point, information such as the root password and any other accounts that need to be created or configured must be provided. A server computer configured with a protocol in accordance with the present invention can automatically and dynamically configure the new computer to add the root password and create or configure accounts

Furthermore, software applications often have their own authentication mechanisms. For example, a deployed server may need to relay email messages to a Simple Mail Transfer Protocol (SMTP) server program on another computer. A protocol in accordance with the present invention can provide to a client the address and login information of an SMTP server running on a different computer system.

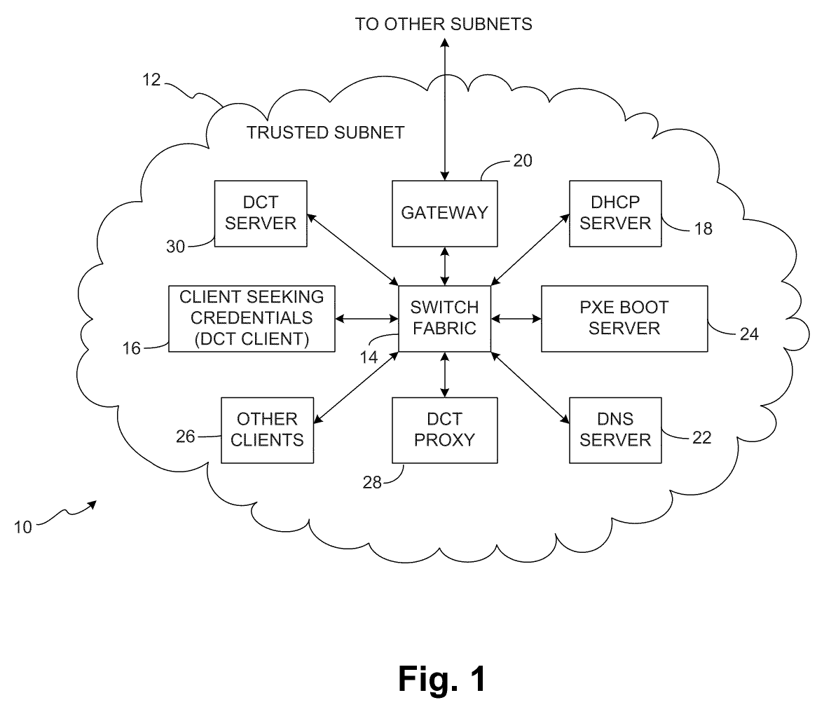

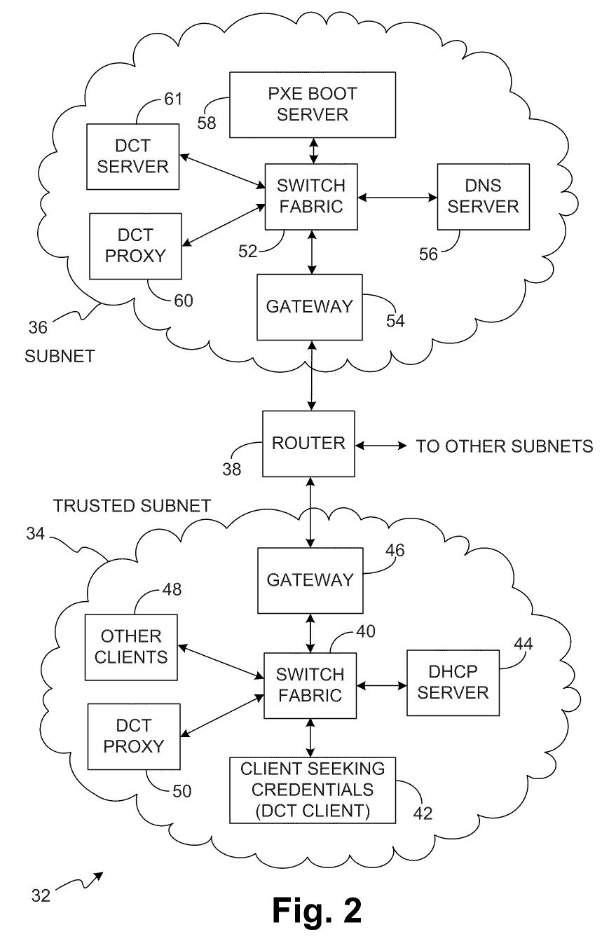

FIGS. 1 and 2 each show a network environment in which embodiments of the present invention may be deployed. The network environments shown in FIGS. 1 and 2 are merely examples, and those skilled in the art will recognize that embodiments of the present invention may be deployed in many other network configurations.

In accordance with embodiments of the present information, credential information is transferred from a Dynamic Credential Transfer (DCT) server to a DCT client. As will be seen below, the level of trust associated with the subnet to which the DCT client is coupled is an important consideration when configuring the client. FIGS. 1 and 2 illustrate networked environments with different levels of trust.

FIG. 1 illustrates network environment 10, in which embodiments of the present invention may be deployed. Environment 10 includes trusted subnet 12 and switch fabric 14. Coupled to switch fabric 14 is client seeking credentials 16 (which includes a DCT client), Dynamic Host Configuration Protocol (DHCP) server 18, gateway 20, DNS server 22, PXE boot server 24, other clients 26 (which represents any other clients coupled to the network), DCT proxy 28, and DCT server 30. Although functions such as DHCP server 18, DNS server 22, PXE boot server 24, DCT proxy 28, and DCT server 30 are shown as separate entities, those skilled in the art will recognize that these functions may (and often will) be hosted on a single server computer, multiple server computers, or dedicated network devices. Finally, gateway 20 couples the trusted subnet 12 to other subnets, which may be hostile or trusted.

FIG. 2 illustrates a network environment 32 in which embodiments of the present invention may also be deployed. Environment 32 includes trusted subnet 34 and subnet 36 coupled by router 38. In FIG. 2, it will be assumed that subnet 36 is not a trusted subnet. However, as will be seen below, if a device in trusted subnet 34 identifies a DCT proxy or DCT server in subnet 36, the DCT proxy or DCT server may be trusted.

In FIG. 2, trusted subnet 34 includes switch fabric 40. Coupled to fabric 40 is client seeking credentials 42 (which includes a DCT client), DHCP server 44, gateway 46, other clients 48 (which represents any other clients coupled to the network), and DCT proxy 50. Gateway 46 is coupled to router 38.

Subnet 36 includes switch fabric 52. Coupled to switch fabric 52 are gateway 54, DNS server 56, PXE boot server 58, DCT proxy 60, and DCT server 61. As in FIG. 1, those skilled in the art will recognize that several of the functions shown in FIG. 2 may be hosted on a single server computer, multiple server computers, or dedicated network devices.

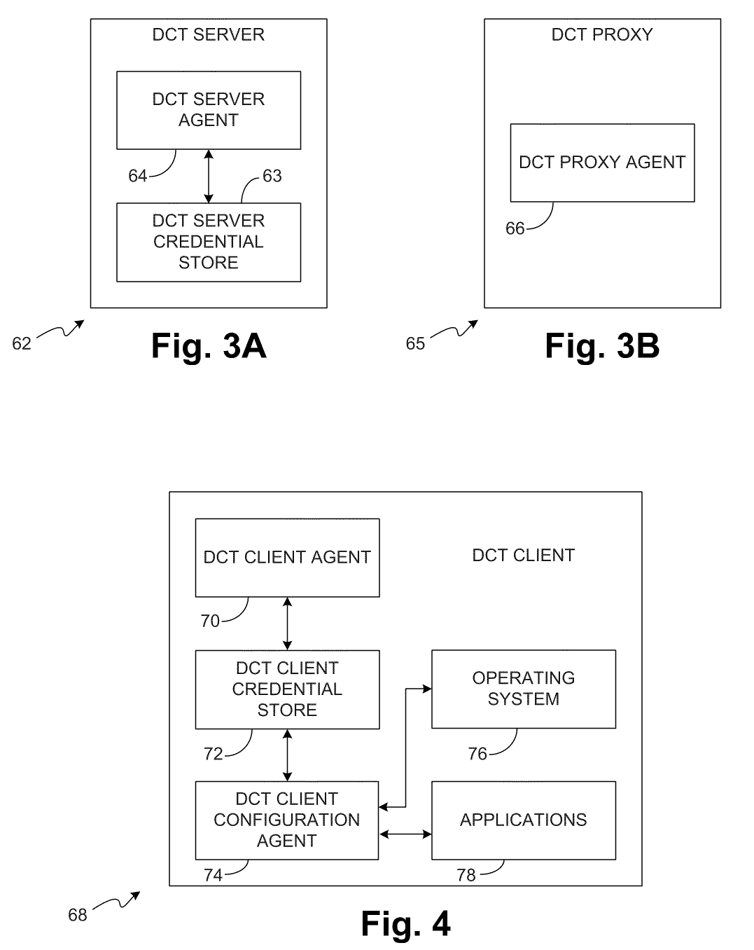

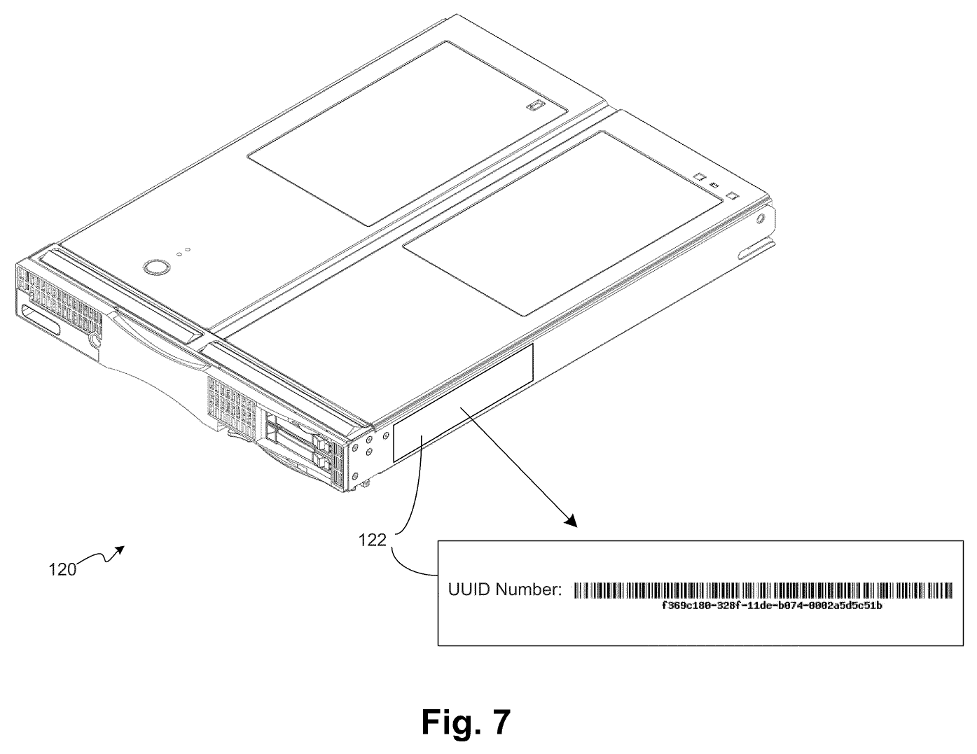

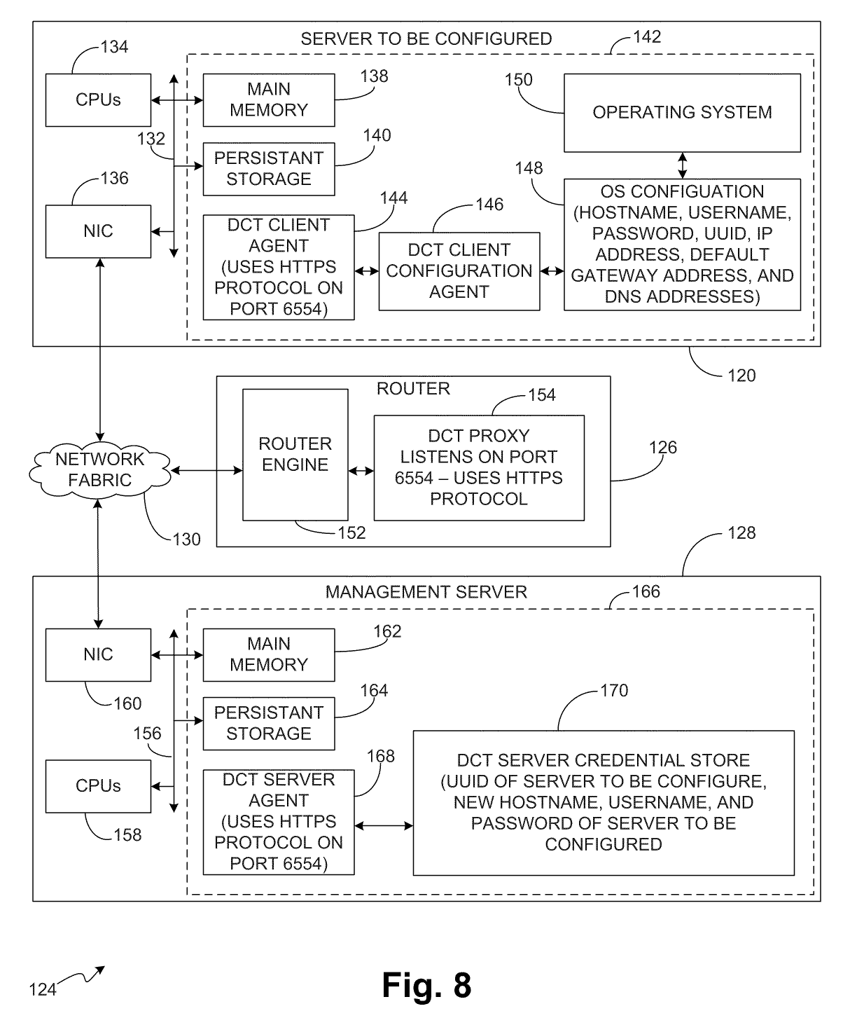

FIG. 3A illustrates DCT server 62, which is similar to DCT server 30 in FIG. 1 and DCT server 61 in FIG. 2. DCT server 62 includes a DCT server credential store 63 and a DCT server agent 64. DCT server credential store 63 stores credentials that will be provided to a client seeking credentials. DCT server agent 64 manages communication with the DCT client seeking credentials, and also manages any authentication, certificates, or encryption, as discussed in greater detail below. Note that in some embodiments, DCT server 62 can be configured to only provide credentials to pre-authorized DCT clients. Such a configuration will be discussed below with reference to FIGS. 7 and 8.

FIG. 3B illustrates DCT proxy 65. DCT proxy 65 includes DCT proxy agent 66. A DCT proxy responds to a request from a DCT client by providing a link to a known DCT server. In one embodiment, the link is an IP address, but those skilled in the art will recognize that the link can be provided in a different format, such as a URL. A DCT proxy may be provided as an independent function. For example, a simple gateway/router can be provided with a DCT proxy to point to a DCT server.

Alternatively, a DCT proxy may be combined with a DCT client or a DCT server. For example, DCT clients may include a DCT proxy that relays a known DCT server address to a DCT client seeking credentials, and a DCT server may include a DCT proxy to direct a DCT client seeking credentials to a different DCT server while the DCT server is being updated or configured.

FIG. 4 illustrates DCT client 68, which is similar to DCT client 16 in FIG. 1 and DCT client 42 in FIG. 2. DCT client 68 includes DCT client agent 70, DCT client credential store 72, DCT client configuration agent 74, operating system 76, and applications 78. DCT client agent 70 manages communication with the DCT server providing credentials, and also manages any authentication, certificates, or encryption, as discussed in greater detail below. DCT client credential store 72 stores credentials that are provided by a DCT server.

Operating system 76 and applications 78 generically represent the operating system and applications found on a typical computer system. DCT client configuration agent 74 receives credential information from DCT credential store 72, and configures operating system 76 and applications 78. For example, DCT client configuration agent 74 can configure root passwords and accounts for operating system 76, and configure applications, such as the URL, login, and password for a remote SMTP server.

While DCT client configuration agent 74 can be configured to “push” configuration data to operating system 76 and applications 78, in another embodiment, operating system 76 and applications 78 can be configured to “pull” credential information from DCT client configuration agent 74. Such a configuration may be advantageous, for example, when a new application is installed after credential information has been stored in DCT client credential store 72, with the newly installed application polling DCT client configuration agent 74 to determine whether agent 74 has credential information available for the application.

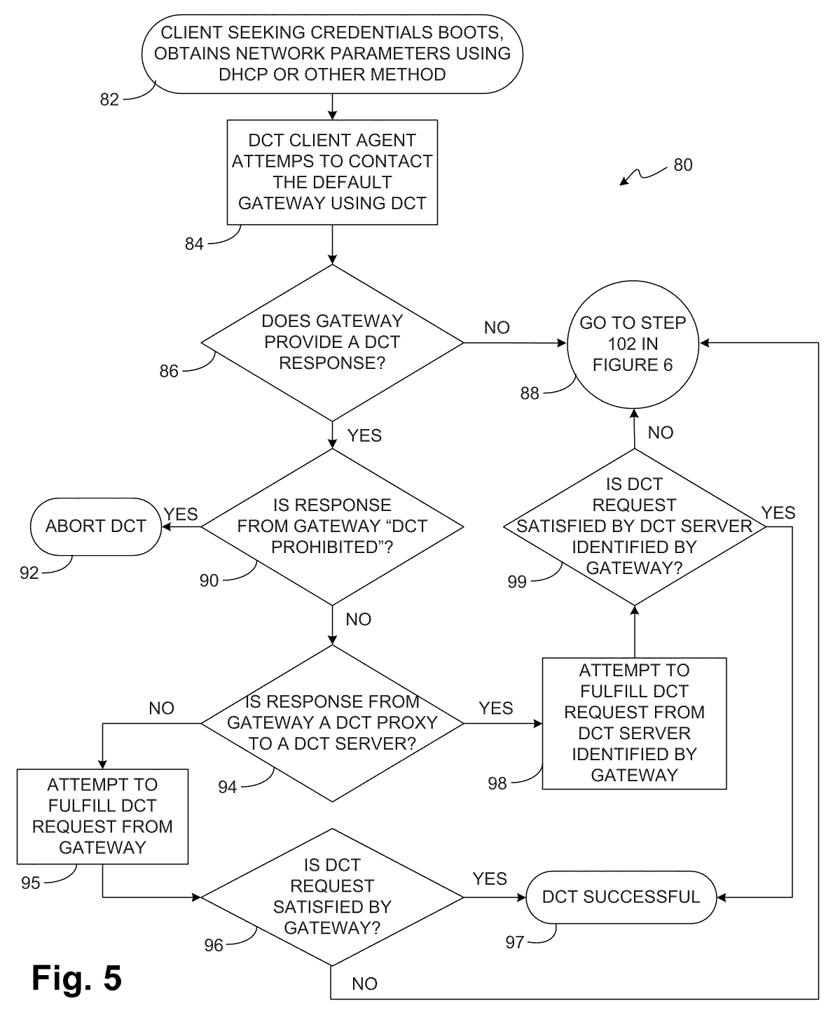

FIG. 5 illustrates a flowchart 80 that describes how a client computer or device seeking credential information, such as client 16 in FIG. 1 or client 42 in FIG. 2, obtains credential information from a DCT server, such as DCT server 30 in FIG. 1 or DCT server 60 in FIG. 2.

In step 82, the client seeking credentials boots and obtains IP configuration parameters, such as the IP address, default gateway address, and DNS servers, using DHCP or any other method known in the art. In step 84. The DCT client agent, such as DCT client agent 70 shown in FIG. 4, attempts to contact the default gateway, such as gateway 20 in FIG. 1 or gateway 46 in FIG. 2, as a DCT server. In accordance with the IP protocol, the default gateway will be on the same subnet as the client, and therefore, a high level of trust may be assumed between the client and the gateway. Note that in other embodiments, the DCT client agent may first contact any network entity identified by a DHCP server, such DNS servers or PXE servers, or the DHCP server itself.

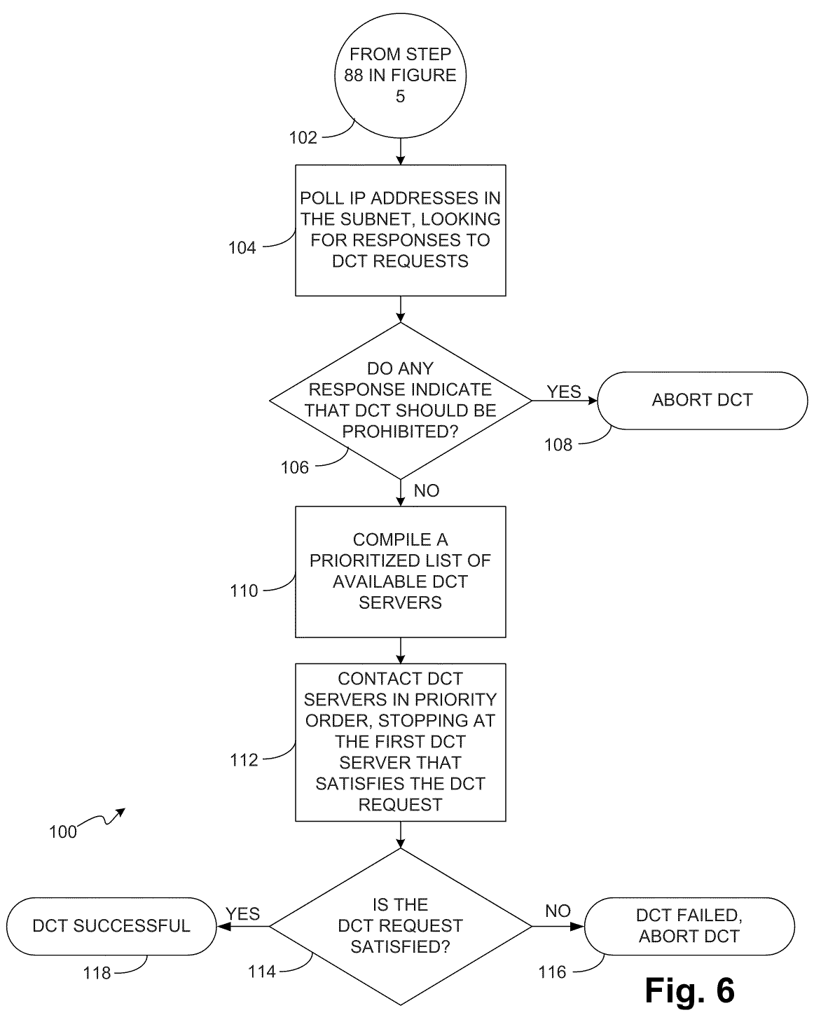

In decision step 86, the DCT client agent determines whether the gateway provides a DCT response. The gateway may not be aware of the DCT protocol, in which case it may respond that the port used for DCT communications is closed, or the connection may simply timeout. If there is not a response, the NO branch is taken from decision step 86 to step 88, which transfers control to step 102 in FIG. 6, which will be discussed below.

If the gateway is configured to provide a DCT response, the YES branch is taken to decision step 90. In accordance with the present invention, a DCT server or DCT proxy may be configured to disable transmission of credential information. If a DCT server or proxy is so configured, the DCT server or proxy provides a “DCT prohibited” message to the DCT client. Decision step 90 determines whether a “DCT prohibited” message has been sent by the DCT server. If transmission of credential information has been prohibited, the YES branch is taken to terminal step 92, which aborts the attempt to receive credential information via DCT and disables further DCT requests.

If the gateway is not configured to disable transmission of credential information, the NO branch is taken to decision step 94. The gateway may fulfill the DCT request as a DCT server, or alternatively, the gateway may, as a DCT proxy, provide a link to a DCT server. The gateway may be a simple device, such as an inexpensive gateway/router. In contrast, the DCT server may be a more complex device storing a significant amount of credential data. By providing a redirection mechanism at the gateway, the present invention provides network administrators with the flexibility to update DCT server software and credential data, without having to reconfigure the device hosting the gateway.

In decision step 94, if the response from the gateway is not a DCT proxy response, the NO branch is taken to step 95. At step 95, the client attempts to fulfill the DCT response from the gateway, and control passes to decision block 96. Decision block 96 determines whether the DCT request has been satisfied by the gateway. If it has, the YES branch is taken to terminal step 97, which indicates that the DCT request has been successful, and therefore, can terminate. If the DCT request is not satisfied by the gateway, the NO branch is taken to step 88, which transfers control to step 102 in FIG. 6.

Returning to decision step 94, if the response from the gateway is a DCT proxy to a DCT server, the YES branch is taken to step 98, which attempts to fulfill the DCT request from the DCT server identified by the gateway. Control than passes to decision block 99, which determines whether the DCT request has been satisfied by the DCT server identified by the gateway. If it has, the YES branch is taken to terminal step 97, which indicates that the DCT request has been successful, and therefore can terminate. If the DCT request is not satisfied by the DCT server identified by the gateway, control passes to step 88, which transfers control to step 102 in FIG. 6.

Note that if the YES branch is taken from decision block 94, the DCT server need not be on the same subnet. For example, in FIG. 2, the client seeking credentials 42 can receive the IP address of DCT server 61 in subnet 36. Even though subnet 36 may not be a trusted subnet, DCT server 61 may be trusted since it was identified by gateway 46.

In FIG. 5, a client attempts to receive credential information by contacting the default gateway on the subnet. As discussed above, that attempt can fail if the gateway does not respond to the DCT request, or the gateway or DCT server identified by the DCT request fails to fulfill the DCT request. If any of these events occur, control passes to flowchart 100 in FIG. 6 to attempt to identify a DCT server using a different method, in accordance with the present invention.

In FIG. 6, control passes from step 88 in FIG. 5 to step 102, which in turn passes control to step 104. In step 104, the client seeking credentials searches for another DCT server by polling IP addresses to find a device on the subnet that responds to a DCT request. In various embodiments, the client can cycle through all IP addresses on the subnet, a sample of IP addresses on the subnet, IP addresses identified by address resolution protocol (ARP) requests, or a sample of IP addresses identified by ARP requests. If a sample of IP addresses are polled, an embodiment of the present invention may be configured to include known addresses on the same subnet that may inherently have a higher level of trust, such as DHCP servers, PXE boot servers, DNS servers, Windows internet name service (WINS) servers, or any other dedicated servers of which the client is aware. Note that a DCT proxy may respond with a link to a DCT server, and the proxy can be a standalone function on a network device, or coupled with a DCT client or server. Of course, a DCT server may also respond and identify itself as a DCT server. Control then passes to decision step 106.

In an alternative embodiment mentioned above, the DCT client agent may first contact any network entity identified by a DHCP server, such DNS servers or PXE servers, or the DHCP server itself. In this embodiment, the gateway may be included in a list of known addresses on the same subnet that may inherently have a higher level of trust, and the first network entity contacted would not be included.

In step 106, the client determines whether any DCT servers or proxies have returned a message stating that DCT should be prohibited. If such a message was received, control passes to terminal step 108 and the DCT request is aborted and further DCT requests are disabled. By allowing a single DCT server, client, or proxy to “veto” DCT, network administrator can easily shut down DCT in a network where a “rouge” DCT server has been introduced. However, in accordance with an alternative embodiment, a client can be configured to not abort DCT upon receiving a single “DCT prohibited” message, but collect all DCT responses and examine the number that returned a “DCT prohibited” message. If the number is greater than a threshold, DCT requests can be aborted and disabled. However, a network administrator should investigate why any DCT server, proxy, or client is trying to disable DCT.

If there are no “DCT prohibited” messages, or it has been determined that the client will proceed despite a certain percentage of “DCT prohibited” messages, control passes to step 110, which compiles a prioritized list of DCT servers. When the client polls the subnet, there may responses from DCT servers, and there may also be responses from DCT proxies identifying DCT servers. One method to prioritize the list of DCT servers is to treat the responses from the DCT proxies as votes, with the DCT servers with the most votes having the highest priority on the list of DCT servers. However, it may be desirable to use other metrics. For example, a DCT server on the same subnet may be preferred over a DCT server on a different subnet. Similarly, a DCT server hosted at the same IP addresses as another network function (such as a DHCP server, a PXE boot server, a DNS server, or a WINS server) may be given priority since the other function may be assumed to already have an inherent level of trust. After the list of available DCT servers has been prioritized, control passes to step 112.

At step 112, the client seeking credentials begins contacting DCT servers in priority order, and ceases contacting DCT servers upon reaching the first server that can satisfy the DCT request. Control then transfers to decision step 114, which determines if the DCT request has been satisfied.

If the DCT request has not been satisfied, the NO branch is taken to terminal step 116. The DCT request has failed, and the DCT process is aborted. If the DCT request has been satisfied, the YES branch is taken to terminal step 118, and the DCT request is terminated successfully.

In various embodiments of the present invention, different levels of encryption and authentication may be used to protect the credential information. For example, DCT server credential store 63 in FIG. 3A and DCT client credential store 72 can be encrypted using methods know in the art, such as the encryption methods used to store user passwords within an operating system. Furthermore, DCT client configuration agent 74 can be configured to supply credentials only to software components having proper digital certificates issued by a certificate authority, such as VeriSign, Inc.

In various embodiments, it is also desirable to encrypt the communication between DCT servers, clients, and proxies. Of course, in a totally secure environment, such as a closed data center, encryption may not be needed. However, encryption may be desirable in many real-world situations.

Consider the network environment shown in FIG. 2. A high level of trust may exist between DCT server 61 and client seeking credentials 42, but the network fabric between the two may be hostile. In one embodiment, the DCT server (or proxy) and the DCT client can exchange public encryption keys and exchange message using encryption techniques know in the art. For example, communications between the DCT client, DCT server, and DCT proxy can occur using the Hypertext Transfer Protocol Secure (HTTPS) protocol.

Potential DCT servers, DCT clients, and DCT proxies may not have a high level of inherent trust. For example, with malicious intent, a rouge DCT client may try to obtain credential information, a rouge DCT server may try to provide invalid credential information, or a rouge DCT proxy may try to redirect to a rouge DCT server. In accordance with another embodiment, DCT servers, DCT clients, and DCT proxies can be provided with a digital certificate issued by a certificate authority, such as VeriSign, Inc.

Alternatively, DCT servers, DCT clients, and DCT proxies can be validated with a secret encryption key that is not publically known. The encryption key can be embedded in firmware of DCT servers, clients, and proxies. In one embodiment, a public/private key pair is used. The private key is kept secret and is stored in firmware. The public key is used to encrypt communications, and the private key is used to decrypt communications. Alternatively, only a secret private key may be used to encrypt and decrypt communications. By having a secret key that is embedded in firmware and is not publically known, trust can be inferred between DCT servers, clients, and proxies having the secret key embedded in firmware.

In the beginning of this section, an example was discussed illustrating how embodiments of the present invention would aid in deployment of a server into LOM data center, with the server having a default hostname, username, and password, all of which need to be changed after the server is deployed. FIGS. 7 and 8 illustrate this example using embodiments of the present invention.

There are many ways that a computer system may be uniquely indentified. For example, asset tags, ownership tags, and chassis serial number are known in the art. Often such identifiers are stored in firmware and are accessible by programs executing on the computer system. Another method of identifying a computer system is a Universally Unique Identifier (UUID), which was standardized by the Open Software Foundation (OSF). Many computer systems having an operating system provided by Microsoft Corporation may be uniquely identified by a Globally Unique Identifier (GUID).

FIG. 7 is a perspective view showing a server 120 that will be configured with a hostname, username, and password, in accordance with embodiments of the present invention. Many computer systems manufactured by Hewlett-Packard Company include a tag showing a UUID that uniquely identifies the computer system. In FIG. 7, computer system 120 includes a tag 122 that shows the UUID. The UUID is provided in human-readable form, and is also provided as a bar code.

As server 120 is being deployed, tag 122 may be scanned by a hand held scanner, or other suitable device. The scanned UUID may be provided to a management server, as will be discussed below. Of course, the UUID may also be entered manually into the management server. In this example, the UUID is merely representative, and those skilled in the art will recognize that other unique identifiers may be used.

FIG. 8 is a block diagram showing a network environment 124, in which server 120 of FIG. 7 will be deployed. In FIG. 8, network environment 124 includes server 120, and router 126 and management server 128, all of which are connected by network fabric 130.

Server 120 includes bus 132. Coupled to bus 132 are one or more central processing units (CPUs) 134, network interface controller (NIC) 136, main memory 138, and persistent storage 140. Persistent storage 140 may represent any persistent storage device known in the art, such as a hard disk drive or flash memory. Main memory 138 and persistent storage 140 are shown in dotted box 142, along with software components represented by DCT client agent 144, DCT client configuration agent 146, OS configuration 148, and operating system 150. The software components are shown within dotted box 142 to illustrate that portions of the software components exist within main memory 138 and persistent storage 140 during various idle and execution states. Of course, those skilled in the art will also recognize that portions of the software components may exist in CPUs 134 during execution. As is known in the art, CPUs typically include cache memory for storing program instructions and data.

In server 120, OS configuration 148 is shown as including a hostname, username, password, UUID, IP address, default gateway address, and DNS addresses. Those skilled in the art will recognize that these parameters are merely representative, and other parameters will also typically be stored. Note that DCT client 68 in FIG. 4 shows DCT client credential store 72. In FIG. 8, the client credentials are stored in OS configuration 148.

In modern computer systems, passwords are typically not stored in clear text form. Rather, passwords are typically stored after application of a cryptographic hash function. Commonly used password hashing algorithms are the Message-Digest Algorithm 5 (MD5) and the Secure Hash Algorithm (SHA-1). Of course, many other cryptographic hash functions are known in the art. Accordingly, when a DTC server provides a password to a DTC client, the password may be sent after application of a cryptographic hash function, thereby providing further security.

When server 120 boots for the first time after being installed, server 120 may obtain an IP address, a default gateway address, and DNS server addresses via DHCP, as described above. Thereafter, DCT client agent 144 is initiated. In this embodiment, DCT client agent uses the HTTPS protocol on port 6554. Of course, other protocols, both secure and unsecure, may be used, any port number not used for another purpose may be used.

As discussed above, the DCT client first attempts to contact the default gateway. In the embodiment shown in FIG. 7, the default gateway is hosted on router 126. Router engine 152 of router 126 represents all the functionality provided by a typical router known in the art. Router 126 also includes DCT proxy 154, which listens for DCT messages on port 6554 using the HTTPS protocol.

Accordingly, DCT client agent 144 of server 120 attempts to contact router 126, and DCT proxy 154 send a DCT proxy response to DCT client agent 144 identifying management server 128 as the DCT server.

Management server 128 includes bus 156. Coupled to bus 156 are one or more CPUs 158, NIC 160, main memory 162, and persistent storage 164. Persistent storage 164 may represent any persistent storage device known in the art, such as a hard disk drive or flash memory. Main memory 162 and persistent storage 164 are shown in dotted box 166, along with software components represented by DCT server agent 168 and DCT server credential store 170. The software components are shown within dotted box 166 to illustrate that portions of the software components exist within main memory 162 and persistent storage 164 during various idle and execution states. As discussed above, portions of the software components may also exist in the CPUs during execution.

After receiving the DTC proxy message from router 126, DCT client agent 144 of server 120 contacts management server 128, and DCT server agent 168 of management server 128 responds with a DCT acknowledgement indicating that it is a DCT server. DCT client agent 144 then sends the UUID of server 120 to DCT server agent 168. DCT server agent validates the UUID against DCT server credential store 170. As discussed above, the UUID of server 120 was previously provided to management server 128.

After validating the UUID, DCT server agent 168 retrieves the new hostname, username, and password from DCT credential store 170, and provides the new hostname, username, and password to DCT client agent 144. DCT client configuration agent 146 of server 120 updates OS configuration 148 with the new hostname, username, and password.

As can be seen by the above discussion with reference to FIGS. 7 and 8, embodiments of the present invention further automate deployment of a server into a networked environment. A tag of the server is scanned using a bar code reader, the server is installed and connected to power and network connections, and booted. Upon booting, the server is automatically and dynamically provided with a new hostname, username, and password from a management server.

The present invention advances the art of networked computing by automating addition steps in the client configuration process. By deploying the DCT protocol of the present invention, opportunities for user error are reduced, and costs associated with deploying new hardware into a network computing environment are also reduced.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computer system comprising:
a bus;
a central processing unit for executing program instructions, the central processing unit coupled to the bus;
a network interface controller for transmitting data to and from a network fabric, the network interface controller coupled to the bus;
memory for storing program instructions and data, the memory coupled to the bus;
persistent storage for storing program instructions and data, the persistent storage coupled to the bus and including data and instructions stored thereon to implement:
an operating system;
an operating system configuration;
a credential transfer client agent for sending a credential transfer message from the computer system to a network entity identified by a dynamic host configuration protocol server and receiving credential information from a credential transfer server; and
a credential transfer client configuration agent, for updating the operating system configuration with the credential information received from the credential transfer server.

2. The computer system of claim 1 wherein the credential transfer server is identified by a credential transfer proxy.

3. The computer system of claim 1 and further comprising:
a tag affixed to the computer system, the tag including a unique identifier.

4. The computer system of claim 1 wherein the credential information is selected from a group consisting of a hostname, a username, and a password.

5. The computer system of claim 1 wherein the credential transfer client agent contacts other known network entities to find the credential transfer server or a credential transfer proxy that provides an address of the credential transfer server if the network entity identified by the dynamic host configuration protocol server does not respond to the credential transfer message.

6. The computer system of claim 1 wherein the credential transfer client agent polls other addresses on a common subnet of the computer system to find the credential transfer server or a credential transfer proxy that provides an address of the credential transfer server if the network entity identified by the dynamic host configuration protocol server does not respond to the credential transfer message.

7. The computer system of claim 1 wherein the credential transfer client agent aborts receiving the credential if a credential transfer prohibited message is received.

8. A method of transferring credential information comprising:
sending a credential transfer message from a client seeking credentials to a network entity identified by a dynamic host configuration protocol server;
identifying a credential transfer server based on sending a credential transfer message from a client seeking credentials to a network entity identified by a dynamic host configuration protocol server; and
receiving credential information at the client from the credential transfer server.

9. The method of claim 8 wherein the network entity identified by the dynamic host configuration protocol server includes the credential transfer server, and identifying a credential transfer server based on sending a credential transfer message from a client seeking credentials to a network entity identified by a dynamic host configuration protocol server and receiving credential information at the client from the credential transfer server collectively comprise receiving credential information from the credential transfer server of the network entity identified by the dynamic host configuration protocol server.

10. The method of claim 8 wherein the network entity identified by the dynamic host configuration protocol server includes a credential transfer proxy, and identifying a credential transfer server based on sending a credential transfer message from a client seeking credentials to a network entity identified by a dynamic host configuration protocol server comprises receiving a credential transfer server address from the credential transfer proxy.

11. The method of claim 8 wherein identifying a credential transfer server based on sending a credential transfer message from a client seeking credentials to a network entity identified by a dynamic host configuration protocol server comprises not receiving a credential transfer response, and contacting other known network entities to find the credential transfer server or a credential transfer proxy that provides an address of the credential transfer server.

12. The method of claim 8 wherein identifying a credential transfer server based on sending a credential transfer message from a client seeking credentials to a network entity identified by a dynamic host configuration protocol server comprises not receiving a credential transfer response, and polling other addresses on a common subnet of the client to find the credential transfer server or a credential transfer proxy that provides an address of the credential transfer server.

13. The method of claim 8 wherein the network entity identified by a dynamic host configuration protocol server comprises a default gateway.

14. The method of claim 8 and wherein receiving credential information at the client from the credential transfer server includes aborting receiving credential information at the client if a credential transfer prohibited message is received.

15. Readable media having computer executable program segments stored thereon, the computer executable program segments comprising:
a credential transfer client agent for sending a credential transfer message from a computer system upon which the computer executable program segments will be executed to a network entity identified by a dynamic host configuration protocol server and receiving credential information from a credential transfer server; and
a credential transfer client configuration agent for updating an operating system configuration of the computer system with the credential information received from the credential transfer server.

16. The readable media of claim 15 wherein the credential transfer server is identified by a credential transfer proxy.

17. The readable media of claim 15 wherein the credential information is selected from a group consisting of a hostname, a username, and a password.

18. The readable media of claim 15 wherein the credential transfer client agent contacts other known network entities to find the credential transfer server or a credential transfer proxy that provides an address of the credential transfer server if the network entity identified by the dynamic host configuration protocol server does not respond to the credential transfer message.

19. The readable media of claim 15 wherein the credential transfer client agent polls other addresses on a common subnet of the computer system to find the credential transfer server or a credential transfer proxy that provides an address of the credential transfer server if the network entity identified by the dynamic host configuration protocol server does not respond to the credential transfer message.

20. The readable media of claim 15 wherein the credential transfer client agent aborts receiving the credential information from the credential transfer server if a credential transfer prohibited message is received.
